(19) United States
(12) Patent Application Publication
(10) Pub. No.: US 2015/0242536 A1
(43) Pub. Date: Aug. 27, 2015

(54) Advanced Search Page with Dynamic Generation of a Search Query String

(71) Applicants: Sergey Surkov, Santa Clara, CA (US); Alexis J. Battle, Palo Alto, CA (US); Raymond J. Pittman, San Francisco, CA (US); Benedict A. Gomes, Mountain View, CA (US); Peter Jin Hong, San Francisco, CA (US); Daniel M. Russell, Palo Alto, CA (US); Nathaniel J. Gaylinn, Mountain View, CA (US)

(72) Inventors: Sergey Surkov, Santa Clara, CA (US); Alexis J. Battle, Palo Alto, CA (US); Raymond J. Pittman, San Francisco, CA (US); Benedict A. Gomes, Mountain View, CA (US); Peter Jin Hong, San Francisco, CA (US); Daniel M. Russell, Palo Alto, CA (US); Nathaniel J. Gaylinn, Mountain View, CA (US)

(21) Appl. No.: 11/875,746

(22) Filed: Oct. 19, 2007

(51) Int. Cl. G06F 17/30

(52) U.S. Cl. CPC G06F 17/30985; G06F 17/30864

(57) ABSTRACT

Systems, methods, and computer software for generating a search query involve displaying a search query entry page that includes multiple fields for entry of search parameters. User input defining at least a portion of a search query for at least one of the fields is received. A formatted search query having a format associated with a predetermined search engine is dynamically generated based on the received user input, and the formatted search query is displayed.

### TECHNICAL FIELD

This document generally describes techniques for dynamically generating a search query string corresponding to search parameters received from a user.

### BACKGROUND

Web search engines enable searching of the Internet for web pages, documents, or other files. Typical search engines provide a web page for entering search queries. A search query may be constructed from words or terms entered onto a web page by a user, and searches may be conducted for web pages or files that contain the words or terms identified in the search query. Results of a search conducted for a particular query may be ranked and listed on one or more search results web pages.

A basic search web page may include a single text box for a user to type in one or more search terms. Some search engines may support the ability to use various operators for modifying or connecting the search terms to facilitate more robust search capabilities. A help page may also provide guidance as to available operators and potential search strategies. In addition, an advanced search page may provide a more structured form for entering search queries. The advanced search page may provide multiple different search fields, each of which corresponds to a different search operation. For example, one field may be a text entry field for entering terms all of which must appear in each listed result, another field may be a text entry field for entering multiple alternative terms only one of which must appear in each listed result, and another field may be a text entry field for entering an exact phrase that must appear in each listed result.

### SUMMARY

This document describes techniques for generating and displaying a search query string corresponding to various search parameters that a user enters into different search fields of a search form, such as an advanced search page, a basic search home page, or a search results page. In general, the search query string may be generated and displayed interactively and/or essentially simultaneously with the user's entry of search parameters into the search fields. The search query string may combine all of the search parameters, including the search terms and their respective search operations, into a single string and may be formatted according to the requirements of a predetermined search language.

In one implementation, user input is received for one or more fields of a search query entry page. The search query entry page includes multiple fields for entry of search parameters, and the received user input defines at least a portion of a search query. A formatted search query is dynamically generated based on the received user input, and the formatted search query has a format associated with a predetermined search engine.

Some implementations may include one or more of the following features. The search query entry page and the formatted search query are displayed. An edit of the displayed formatted search query is received, and the edit is applied to the formatted search query. The edited formatted search query is displayed, and a search is performed with the edited formatted search query. User input for two or more of the fields is received, and the received user input for the two or more fields defines at least a portion of the search query. The search query entry page is an advanced search query entry page, a basic search query entry page, or a search results page. Each of the fields includes a distinct data entry field corresponding to a different search operation. The different search operations include a list of terms that must all be found in the search results, a list of terms for which at least one of the terms must be found in the search results, a list of terms that must not be found in the search results, an exact phrase, a date limitation, a language limitation, a file type limitation, a web site limitation, a domain limitation, and/or a location limitation for one or more search terms.

Some of the fields are text boxes adapted to receive text entry. The formatted search query is displayed as the formatted search query is dynamically generated. A search is performed with the predetermined search engine using the formatted search query. The user input defines multiple search parameters, and each search parameter is associated with at least one available search query operation. The available search query operations and the search query string are displayed on a client user interface. The search query is generated and displayed substantially simultaneously with receiving the user input. The search query is displayed in a text box.

In another implementation, a web page including multiple query component input fields is generated, and the web page is adapted to display a formatted search query in response to receiving user input to the query component input fields. The formatted search query are generated based on the user input to the query component input fields, and the web page is transmitted to a client device for display and for receiving user input.

Some implementations may include one or more of the following features. The web page includes at least one script adapted to generate and display the formatted search query. The script can be adapted to generate the formatted search query by combining the user input to the query component input fields in a predetermined sequence or in a sequence corresponding to a sequence of user input.

The described techniques may be implemented as a computer-implemented method, a system, software, or instructions stored on a machine-readable medium.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 is a block diagram of a system for displaying a formatted search query corresponding to search parameters entered into fields of an advanced search page.

FIGS. 2A-2C are example screenshots of an advanced search web page that can be used to enter search terms and parameters while displaying a formatted search query on the same web page.

FIG. 3 is a screenshot of an advanced search web page that illustrates an example of a formatted search query generated based on search terms entered into the individual search operation fields of the advanced search page.

FIG. 4 is a screenshot of an alternative advanced search web page.

FIG. 5 is a flow diagram of a process for dynamically displaying a search query corresponding to components of an advanced search form.

Like reference symbols in the various drawings indicate like elements.

### DETAILED DESCRIPTION

Systems, techniques, and software may be implemented to facilitate generating and displaying formatted search query strings that correspond to search parameters from the various fields of an advanced search form. These techniques may be used, for example, in connection with an optional advanced search web page of an Internet search engine. The search parameters may include search terms that are entered in the fields of the advanced search form alone or as modified by operators corresponding to each of the fields. For example, each field of the advanced search form may represent a different potential search operation that may be performed on or using the search terms entered into the search field. The formatted search query string may be a single string that combines all of the search parameters according to a search language format used by a particular search engine.

The formatted search query string may be generated while search terms and other search parameters are entered into the advanced search form by a user. In addition, the formatted search query string may be displayed as it is generated. Thus, the formatted search query string may be displayed at the same time and on the same page or on the same user interface as a user is formulating the overall search query. By generating the formatted search query string substantially simultaneously with the user's entry of search terms and selection of search parameters, the user may be able to efficiently learn how certain search operations can be specified in the search language format. In other words, the advanced search page may illustrate how to manually enter one or more search operations, such that the user may be able to more quickly enter search queries in the future without using the advanced search option. The user may also be able to efficiently learn how to construct relatively complex search queries in the search language format. Particularly as the number of available advanced search options increase, the ability to learn to construct complex search queries or to at least perform certain specialized search operations may become even more beneficial because it may allow a user to avoid having to visually and/or electronically navigate through large numbers of available search operation fields, particularly for search operations that the user employs on a regular basis.

In some implementations, a user may be permitted to directly modify the formatted search query string after it has been completely or even partially generated, instead of requiring the user to make any modifications to the individual fields of the advanced search form. Such modifications to the formatted search query string may also be reflected in the individual advanced search form fields by automatically making corresponding changes to the fields. The ability to directly modify the formatted search query string may allow for more efficient or convenient searching. On the other hand, if the user modifies the search query by modifying the information entered into one or more of the fields of the advanced search form, the user may be able to observe how the modifications change the formatted search query string. Either way, the user may be able to efficiently learn how to construct queries in the format of the applicable search language.

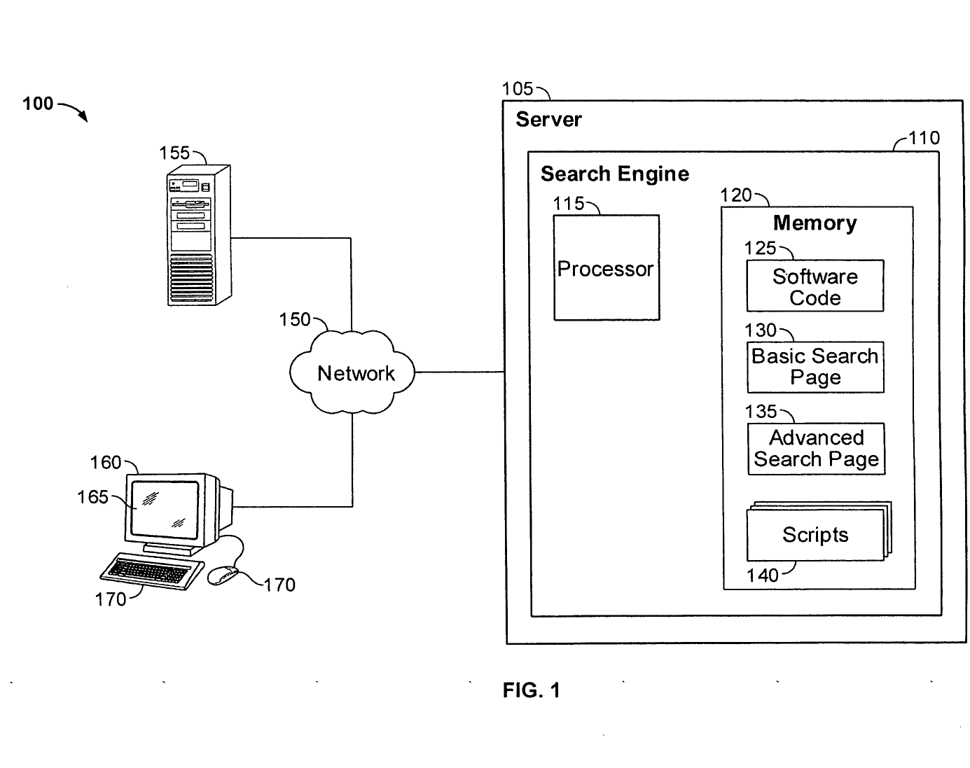

FIG. 1 is a block diagram of a system 100 for displaying a formatted search query corresponding to search parameters entered into fields of an advanced search page. The system 100 includes a server 105 that supports a search engine 110. The search engine 110 may be accessed across a network 150 from multiple client devices 160, each of which may be located locally or remotely from the server 105. The search engine 110 may be accessed by the client devices 160 to perform searches for web pages, documents, or other files available from the server 105 or from other servers 155 accessible through the network 150 or through other networks or connections (not shown). In some implementations, the search engine 110 may be supported by multiple servers in, for example, a distributed server architecture.

The server 105 includes a processor 115 and a memory 120 that may support the functionality of the search engine 110. In particular, the processor 115 may execute software code 125 stored in the memory 120 to carry out the operations of the search engine 110. The memory 120 may also store data defining the content and operations of web pages associated with the search engine 110, including, for example, a basic search page 130 and an advanced search page 135. When a request for the basic search page 130 is received at the server 105 from a client device 160, the processor 115 retrieves the basic search page 130 and transmits the basic search page 130 to the client device 160. Similarly, when a request for the advanced search page 135 is received at the server 105 from a client device 160, the processor 115 retrieves the advanced search page 135 and transmits the advanced search page 135 to the client device 160. The basic search page 130 and the advanced search page 135 may incorporate one or more scripts 140 that may be transmitted to the user device 160 along with the respective search pages 130 and 135. The scripts 140 may be used for executing specialized functions, such as automatically generating and displaying a formatted search query corresponding to the search parameters defined on the advanced search page 135.

Each client device 160 includes a user interface, such as a display screen 165, for displaying or otherwise presenting information such as the search pages 130 and 135 to a user. The search pages 130 and 135 may be presented using a web browser on the client device 160. The client device 160 may also include one or more input devices 170, such as a touch screen, a mouse, and a keyboard, for receiving user input. When the client device 160 receives the basic search page 130, the basic search page 130 may be displayed on the display screen 165. The basic search page 130 may include a field for receiving user input defining a search query. The basic search page 130 may also include a link to the advanced search page 135.

When the client device 160 requests and receives the advanced search page 135 (e.g., by clicking on a link on the basic search page 130), the advanced search page may be displayed on the display screen 165. The advanced search page 135 may include a plurality of search query component fields, each of which may relate to a different search operation. The advanced search page 135 may also include a text box for displaying a formatted search query corresponding to a combination of search parameters entered into the search query component fields. As a user uses the input devices 170 to enter search terms and other search parameters in the search query component fields, one or more scripts 140 associated with the advanced search page 135 may operate to automatically generate a formatted search query and display the formatted search query in the designated text box. The text box need not include a visible boundary or outline but can simply be a designated area of the advanced search page 135.

In some implementations, as an alternative to, or in addition to, scripts that automatically generate and display the formatted search query, other techniques for generating and displaying the formatted search query may be used. For example, search terms and other parameters entered into the search query component fields can be sent to the server 105, which can update the advanced search page 135 using software code 125 executed on processor 115 and return the updated advanced search page 135 to the client device 160.

Once a search query is generated in either the basic or advanced search page 130 or 135, the search query can be submitted to the server 105. The processor 115 and associated software code 125 stored in the memory 120 and defining the operation of the search engine 110 can be used to conduct a search based on the search query. For example, the search engine may be the Google™ search engine (www.google.com) or any other search engine. A result list may be generated and transmitted to the client device 160 for display on the display screen 165.

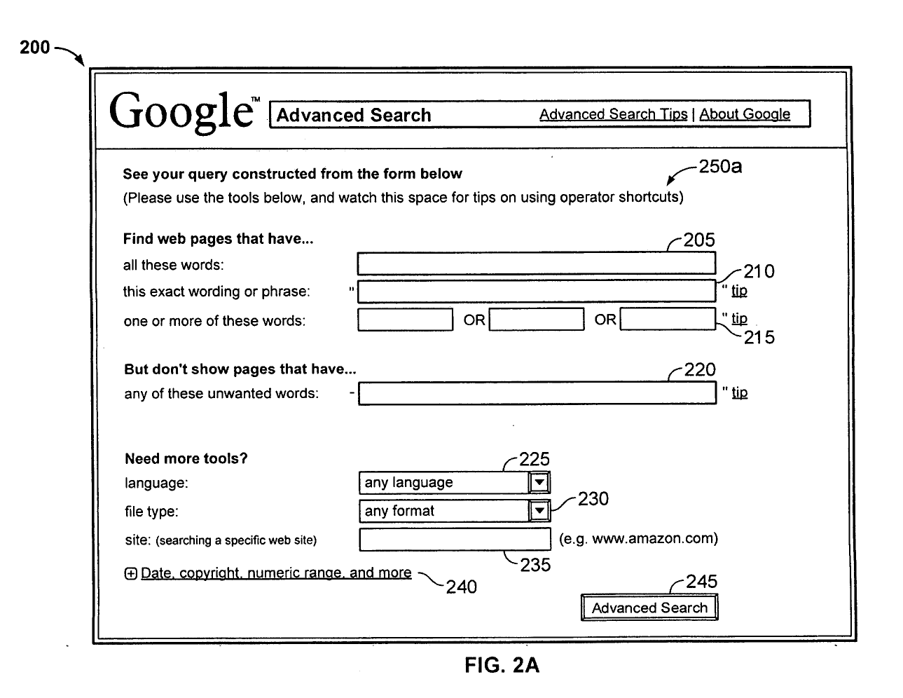

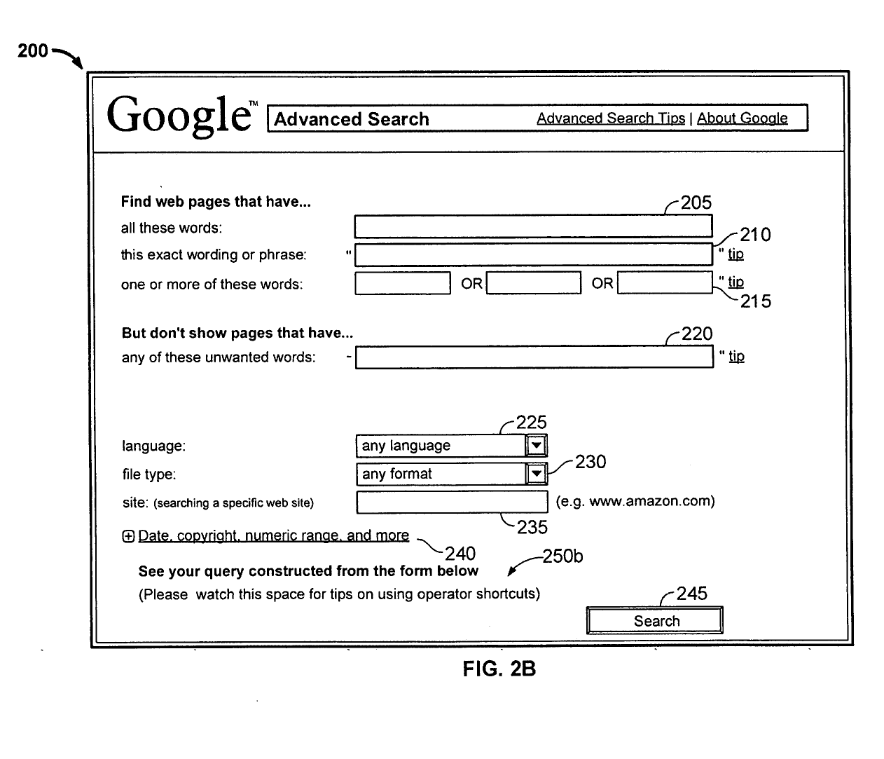

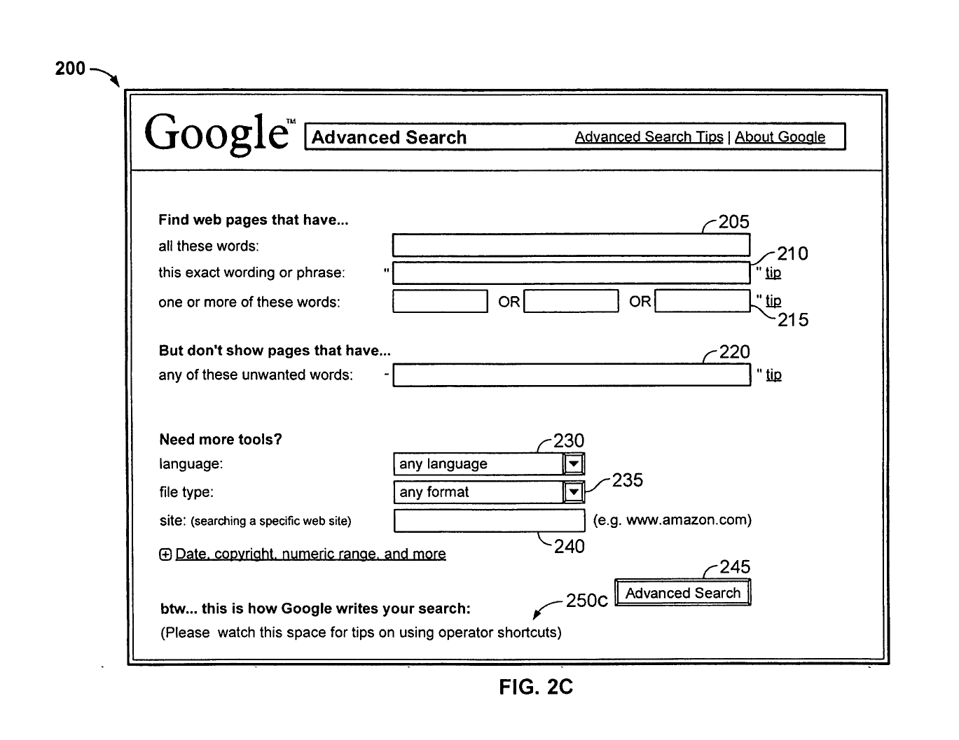

FIGS. 2A-2C are example screenshots of an advanced search web page 200 that can be used to enter search terms and parameters while displaying a formatted search query on the same web page 200. The advanced search page includes a first text entry field 205 for specifying a list of one or more words that must all be included (i.e., an AND operation), a second text entry field 210 for specifying an exact phrase that must be included (i.e., an exact phrase operation), a third text entry field 215 for specifying a list of words for which one or more must be included (i.e., an OR operation), and a fourth text entry field 220 for specifying a list of one or more words that must not be included in any web page results (i.e., a NOT operation). Other search fields include a first drop-down menu field 225 for specifying language parameter, a second drop-down menu field 230 for specifying a file type parameter, and a fifth text entry field 235 for identifying a specific web site to search within. A link 240 to other available search operations is also included. Other search operations may include date limitations (e.g., a date range; a specific year, month, or day; and the like), domain limitations (e.g., “.org” domains), and location limitations (e.g., in the title) for one or more search terms. In some implementations, search parameters may be selected using radio buttons, checkboxes, alphanumeric data entry fields, numeric data entry fields, numeric ranges, date fields, date ranges, language limitations, file format limitations, coded information entry fields, other constrained data entry fields, or other user interface components. Typically, users may enter search terms and/or parameters in only some of the available query component fields, while leaving other fields blank.

The advanced search web page 200 includes a search button 245 that a user can select to initiate the search (e.g., when the search query is complete) and an area 250a, 250b, or 250c for displaying a formatted search query string that corresponds to the search terms and other parameters specified in the various fields of the advanced search web page 200. The display area for the formatted search query string can be located, for example, at the top of the advanced search web page 200 (at 250a as in FIG. 2A), at the bottom of the advanced search web page 200 above the search button 245 (at 250b as in FIG. 2B), or at the bottom of the advanced search web page 200 below the search button 245 (at 250c as in FIG. 2C). Other locations on the advanced search web page 200, on a standard search query page, or on a search results page are also possible. Furthermore, locations other than on the advanced search web page 200 are possible, such as in a pop-up window, in another static window, or in a toolbar.

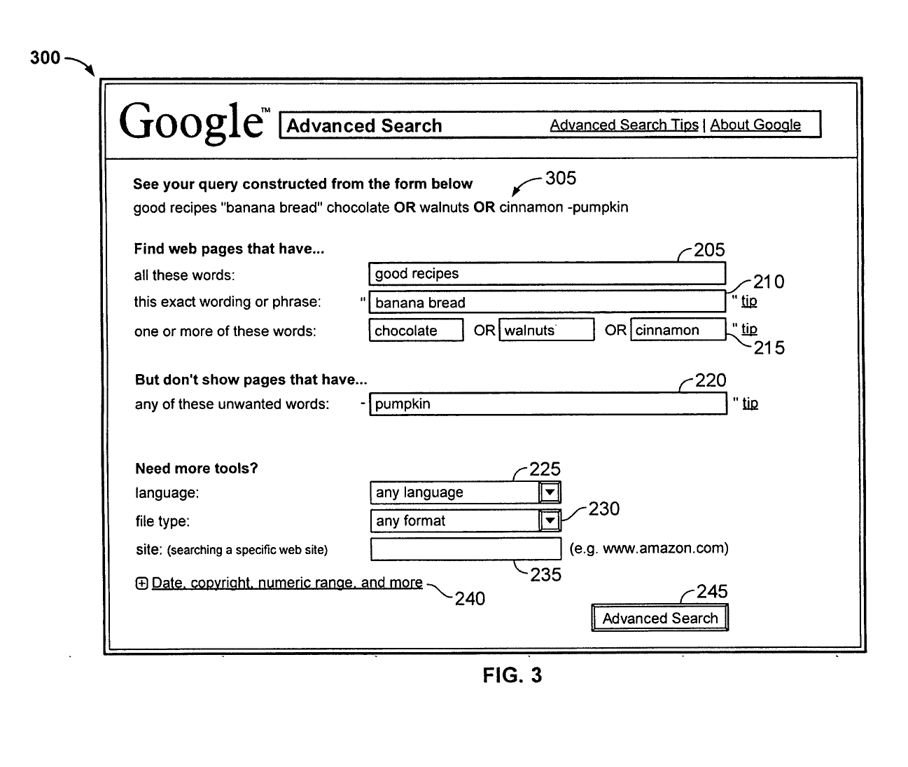

FIG. 3 is a screenshot of an advanced search web page 300 that illustrates an example of a formatted search query 305 generated based on search terms entered into the individual search operation fields 205, 210, 215, and 220 of the advanced search page 300. In the illustrated example, the formatted search query is formatted according to the Google™ search language format. Also in this example, the search parameters are placed in a predetermined sequence in the formatted search query 305 according to the sequence of the advanced search operation fields 205, 210, 215, and 220. In some implementations, the sequence of search parameters in the formatted search query string may depend, at least in part, on the order in which the search terms and parameters are entered onto the advanced search web page 300. In other implementations, the sequence of search parameters in the formatted search query string may be based on some combination of predetermined sequencing rules and the order in which search terms and parameters are entered by a user.

The formatted search query string may be generated and displayed at least substantially simultaneously with the user's entry of search terms and parameters into the advanced search web page 300. In some implementations, there may be no perceptible delay between entering a character in one of the individual search operation fields 205, 210, 215, and 220 and displaying the corresponding change in the formatted search query string. In other implementations, there may be a greater delay, but modifications to the formatted search query string may generally be displayed quickly enough for a user to recognize the connection between changes in the individual search operation fields 205, 210, 215, and 220 and corresponding changes to the formatted search query string.

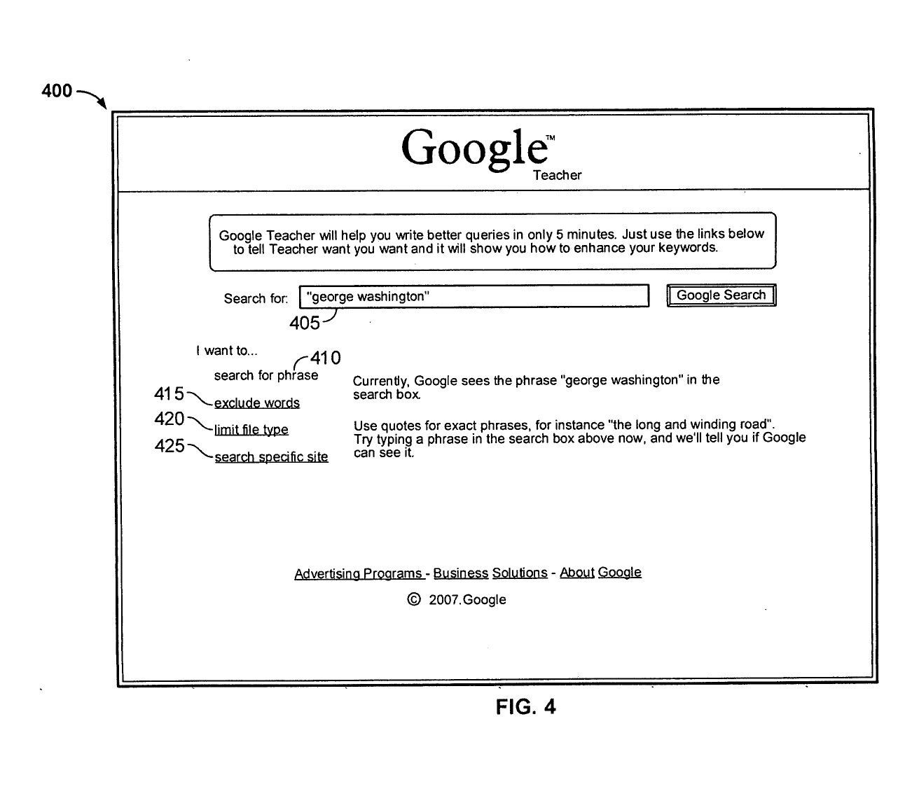

FIG. 4 is a screenshot of an alternative advanced search web page 400. In this implementation, instead of including a plurality of individual search operation fields, the advanced search web page 400 includes a single search text box 405 and a plurality of links for different available advanced search operations. For example, the illustrated advanced search web page 400 includes an “exact phrase” link 410, an “exclude words” link 415, a “file type” link 420, and a “specific web site” link 425. Links for other available options could also be included. After a user selects one of the available links 410, 415, 420, or 425, the corresponding search operation is applied to search terms that are entered into the search text box 405 while the selected link remains active. In the Figure, the user has chosen link 410 (search for phrase) and the query 405 has quotes around the phrase “George Washington.” In some implementations, a warning may be presented to the user if the user attempts to enter search terms or parameters that are not appropriate for a particular, active search operation (or in the case of the advanced search forms depicted in FIGS. 2A-2C, for a particular search operation field).

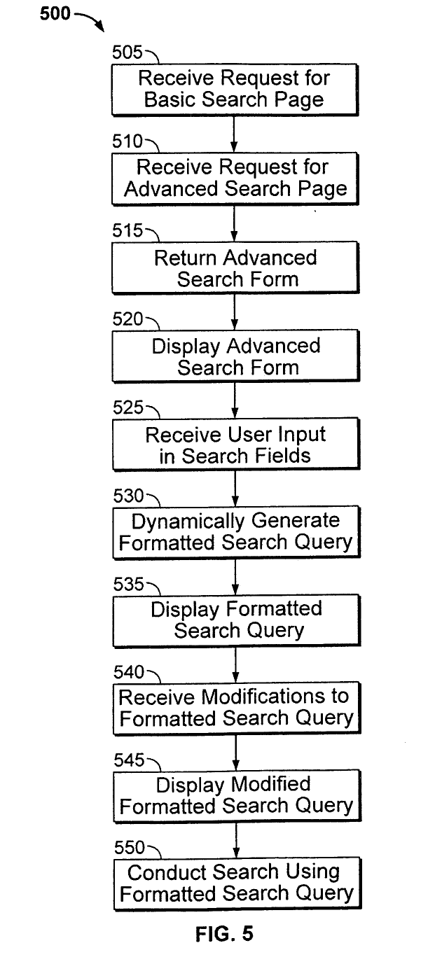

FIG. 5 is a flow diagram of a process 500 for dynamically displaying a search query corresponding to components of an advanced search form. A request for a basic search page is received (505). The request may be received from a client device, such as a desktop or laptop computer, a workstation, a mobile handheld device, or other device. Typically, searches performed using the basic search page are based on a search query that the user enters into a single search query field. In some cases, however, the basic search page may include more than one search query field. The basic search page may include a link or button that allows a user to request an advanced search form.

A request for an advanced search form may be subsequently received (510). The request may be received from a client device when a user selects the appropriate link or button on the basic search page or from a different client device using a direct link to the advanced search form. The advanced search form is returned in response to the request (515). The advanced search form may be provided by a server or a plurality of distributed servers that store the advanced search form and/or that support a search engine associated with the advanced search form. The advanced search form generally includes multiple fields for entry of search parameters. Typically, the advanced search form includes a greater quantity of search query fields than the basic search form. Each field of the advanced search form is a distinct data entry field and may correspond to a distinct search operation (e.g., a Boolean search operation or other search constraint operation).

The advanced search form is displayed (520) on, for example, a user device. The advanced search form may be displayed on a display screen using browser software on the user device. User input for one or more of the fields is received (525). The received user input defines at least a portion of a search query. For example, the received user input for each field may define one of a plurality of search parameters. Generally, user input is received for more than one of the fields on the advanced search form and the received user input defines at least a portion of an overall search query.

A formatted search query is interactively and/or dynamically generated based on the received user input (530). The formatted search query may be automatically generated and generally has a format associated with a predetermined search engine (e.g., a search language format required by the search engine). The formatted search query may be a Boolean search query generated by combining multiple search parameters corresponding to the various fields of the advanced search form in which the user enters data.

The formatted search query is displayed (535) on, for example, the user device. The formatted search query may be generated and displayed substantially simultaneously with the entry of user input (at 525). A user may modify the formatted search query (540). Modifications may be made directly to the formatted search query or to the individual data entry fields (545), in which case corresponding changes are made to the displayed formatted search query. Modifications may include deleting search terms or search parameters from the search query. Modifications and the display thereof (540 and 545) can be repeated multiple times for as many edits as the user makes to the query.

A search is conducted using the predetermined search engine based on the formatted search query (550). Search results are generally returned to the requesting user device for display on a search results page.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for dynamically generating and displaying a search query string may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A computer-implemented method of generating a search query, the method comprising:
receiving user input for a search query entry web page received over a network from a server and displayed on a user interface of a client device, the displayed search query entry web page including search query component fields for entry of search parameters, each search query component field in the search query entry web page corresponding to a different search operation, wherein the received user input includes search parameters, including character strings entered by a user, in a selected plurality of search query component fields that define at least a portion of a search query;
dynamically generating, at the client device and substantially simultaneously with the user input being received in the selected plurality of search query component fields, a formatted search query character string based on the received user input including the received character strings using one or more scripts included in the search query entry web page and executed on the client device, wherein the formatted search query character string has a predefined format associated with a predetermined search engine, the predefined format including a string of characters indicating the search parameters and the search operations corresponding to the selected plurality of search query component fields; and
displaying, substantially simultaneously with the received character strings entered by the user in the selected plurality of search query component fields, the formatted search query character string including the received character strings on the user interface concurrently with displaying the search query entry page and before executing a search based on the received user input, wherein the formatted search query character string is displayed on the user interface using the one or more scripts.

2. (canceled)

3. The method of claim 1 further comprising:
receiving an edit of the displayed formatted search query character string;
editing the formatted search query character string;
displaying the edited formatted search query character string on the search query entry web page before executing a search on the predetermined search engine based on the received user input; and
performing a search with the edited formatted search query character string.

4. (canceled)

5. The method of claim 1 wherein the search query entry web page comprises an advanced search query entry web page.

6. (canceled)

7. The method of claim 1 wherein the different search operations include at least two search operations from the group consisting of: a list of terms that must all be found in one or more search results, a list of terms for which at least one of the terms must be found in the search results, a list of terms that must not be found in the search results, an exact phrase, a date limitation, a language limitation, a file type limitation, a web site limitation, a domain limitation, and a location limitation for one or more search terms.

8. The method of claim 1 wherein at least two of the search query component fields include a text box adapted to receive text entry.

9. (canceled)

10. The method of claim 1 further comprising performing a search with the predetermined search engine using the formatted search query character string.

11. An article comprising a non-transitory computer-readable storage device storing instructions for causing data processing apparatus to perform operations comprising:
receiving user input defining a plurality of search parameters, each search parameter including character strings entered by a user and received in a different search query component field of a selected plurality of search query component fields included in a search query entry web page received over a network from a server and displayed on a user interface of a client device, wherein each search query component field is associated with a different available search operation;
generating, at the client device and substantially simultaneously with the user input being received in the selected plurality of search query component fields, a formatted search query character string defining the plurality of search parameters and the associated search operations input using one or more scripts included in the search query entry web page and executed on the client device, wherein the formatted search query character string includes, for each search operation in at least a subset of the search operations, at least one character identifying the search operation in accordance with a predefined search query format; and
displaying, substantially simultaneously with the received character strings entered by the user in the different search query component field of the plurality of search query component fields, the formatted search query character string including the received character strings on the user interface concurrently with displaying the plurality of search query component fields and before executing a search based on the received user input.

12. The article of claim 11 wherein the computer-readable storage device stores instructions for causing data processing apparatus to perform further operations comprising:
displaying a plurality of search query component fields corresponding to the available search operations in a search query entry web page; and
displaying the search query string in the search query entry web page.

13. (canceled)

14. The article of claim 11 wherein the search query character string is formatted according to a predetermined search string format for search engine.

15-16. (canceled)

17. The article of claim 11 wherein the instructions are operable to cause data processing apparatus to perform further operations comprising:
receiving user input defining a modification to at least one of the plurality of search parameters;
generating a modified search query character string corresponding to the search query string with the modification; and
displaying the modified search query character string.

18. The article of claim 11 wherein the instructions are operable to cause data processing apparatus to display the formatted search query character string in a text box.

19. The article of claim 18 wherein the instructions are operable to cause data processing apparatus to display the text box in a single window with the search query component fields for the available search query operations.

20. An electronic system for displaying a formatted search query character string, comprising:
a processor; and
a memory for storing instructions for execution by the processor, the instructions operable to cause the processor to:
generate a web page including a plurality of search query component fields each corresponding to a different search operation, wherein the web page:
receives user input, including character strings entered by a user, defining search parameters in a selected plurality of the search query component fields; and
is adapted to display a formatted search query character string in response to, and substantially simultaneously with, receiving user input, including character strings entered by a user, defining search parameters in a selected plurality of the search query component fields, the formatted search query character string dynamically generated, substantially simultaneously with the user input being received in the selected plurality of search query component fields, based on the user input to the search query component fields, displayed concurrently with displaying the user input in the selected plurality of search query component fields before executing a search based on the received user input, and having a predefined format associated with a predetermined search engine, the predefined format including a string of characters indicating the search parameters and the search operations corresponding to the selected plurality of search query component fields; and
includes at least one script adapted to perform at least one of:
generating and displaying the formatted search query character string including the received character strings on a user interface concurrently with, and substantially simultaneously with the received character strings entered by the user in the selected plurality of search query component fields and before executing a search based on the received user input; or
generating and displaying modified search parameters in the query component input fields concurrently with, and substantially simultaneously with, receiving user input defining an edit to a display of the formatted search query character string and before executing a search based on the received user input; and
transmit the web page to a client device for display and for receiving user input.

21. (canceled)

22. The system of claim 20 wherein the memory further stores instructions operable to cause the processor to receive a request for an advanced search interface, wherein the web page is transmitted in response to the received request.

23. The system of claim 20 wherein the web page includes at least one script adapted to generate the formatted search query character string by combining the user input to the query component fields in a predetermined sequence.

24. The system of claim 20 wherein the web page includes at least one script adapted to generate the formatted search query character string by combining the user input to the search query component fields in a sequence corresponding to a sequence of user input.

25. (canceled)

26. The method of claim 1 wherein the predefined format associated with the predetermined search engine includes operators corresponding to at least a subset of the search query component fields, each operator including one or more characters specifying the search operation corresponding to the search query component field.

27. The method of claim 1 wherein the search query entry web page comprises an advanced search query entry web page of the predetermined search engine adapted to receive search parameters in the search query component fields, the predetermined search engine further including a basic search query entry page adapted to receive queries formatted according to the predefined format, and wherein the predetermined search engine is adapted to perform a search based on search parameters received through the advanced search query entry page and to perform a search based on search parameters received through the basic search query entry web page.

28. The method of claim 3 further comprising:
editing one or more search parameters in the search query component fields corresponding to edited portions of the edited formatted search query character string; and
displaying the edited search parameters in the corresponding search query component fields before executing a search based on the received user input.

29. The method of claim 1 further comprising:
receiving an edit of a search parameter in the search query component fields before executing a search based on the received user input;
editing the formatted search query character string based on the edit of the search parameter; and
displaying the edited formatted search query character string on the search query entry web page before executing a search based on the received user input.

30. The article of claim 17 wherein the modification is received as a modification to the displayed formatted search query character string and the instructions are operable to cause data processing apparatus to perform further operations comprising:
modifying a search parameter from one of the search query component fields based on the modification to the displayed formatted search query character string; and
displaying the modified search parameter on the user interface in a search query component field.

31. The article of claim 17 wherein the modification is received as a modification to a search parameter displayed on the user interface in a search query component field.
